(19) United States
(12) Patent Application Publication
(10) Pub. No.: US 2014/0372405 A1
(43) Pub. Date: Dec. 18, 2014

(54) COMPUTER-BASED COLLABORATIVE RESEARCH SERVICE

(71) Applicant: edtwist Inc., Topanga, CA (US)

(72) Inventors: Julie Lee, Topanga, CA (US); Calvin Oh, Topanga, CA (US)

(21) Appl. No.: 14/304,858

(22) Filed: Jun. 13, 2014

Related U.S. Application Data
(60) Provisional application No. 61/835,467, filed on Jun. 14, 2013.

(51) Int. Cl. G06F 17/30

(52) U.S. Cl. CPC G06F 17/30864
USPC 707/711

(57) ABSTRACT

A web-based computer system is programmed to present a user interface to a user for viewing with a browser program or mobile application. The user can enter a search query into the interface and the computer system forwards the received search query to a search engine. Search results are received from the search engine and the computer system creates a search record for at least one search result. The computer system is programmed to allow the user to save search records to a board. In addition, the user can add one or more of text, videos, URL links, tables and code segments to a search record. In one embodiment, a user can augment the search records by entering search terms into a search bar that is present on the board.

### CROSS-REFERENCE TO RELATED APPLICATION(S)

The present application claims the benefit of and priority to U.S. Provisional Application No. 61/835,467 filed Jun. 14, 2013, which is herein incorporated by reference in its entirety.

### TECHNICAL FIELD

The technology disclosed herein relates generally to computer systems and in particular to computers that query, store and recall information about particular topics and are accessible from the Internet and from mobile devices.

### BACKGROUND

Despite the prevalence of Internet search engines and their ability to surface billions of potential answers as search results in response to a specific query, there is lack of a search platform that is able to surface a corpus of search results, where each search result represents a bundle of relevant information that has been curated by a human drawn from his/her learning and experience as they research. This is particularly necessary in instances (i.e. not only looking for an answer to a single question) where answers are sought for a series of questions (queries may include “where,” “why,” “how,” “who,” “when” as well as “what”).

Search engines recognize and record patterns associated with whether a user clicked-through to view a result, but beyond that, any further engagement with the result information is lost. The process and effort of a human, as they research, curate, contextualize, correlate with other information and update based on their experience in engaging with the information that is found on the web is important in helping a person discover not only the answer to a particular question, but also to guide alternative answers and questions. Gaining insight into this process in which previous information was not only searched (same search results are possible by entering the same search query) but also how the human engaged with the information and connected it to other information, helps the subsequent researcher to learn from the prior researcher's experience.

Despite the prevalence of search engines that either index the web (e.g. Google, Yahoo, Bing)/niche internal content (e.g. YouTube, Tumblr) or curation platforms that save user curated information (e.g. Evernote, Pinterest), there is lack of a platform that integrates search engines (i.e. enable search on the web and niche internal content) with a curation platform or vice-versa (curation platform that enables a user to conduct a search on the web and internal/external niche content and then bring the results into the platform). For example, if a student was interested in learning about tree frogs, the student might type multiple search queries (e.g. “what does tree frog look like’, “where does tree frog live,” “what does tree frog eat,” “who preys on tree frog,” “how does tree frog protect itself”) into a search engine (Google, Yahoo, Bing etc.) and sort through potential answers for each query. The user may also watch videos, view images, read blog posts or articles that came up in the search results. The user then has to keep track of their search results.

A user could bookmark a page with useful results or keep notes of where to find the information. If the user wants to return to a previously found search result, the user can select a previously stored bookmark. The problem with this approach is that bookmarked links are typically only available on the specific browser that the user used when bookmarking a link. Bookmarking stores a website URL without allowing the user to add information on the significance of the search result in context of the user's research (e.g. synopsis explaining why the search result has been bookmarked). Additionally, the option to bookmark search results in a computer's browser only exists for those who own a personal computer as those users conducting online research on public computers (e.g. at the library or school) cannot save bookmarks to the public computer. A user typically deals with these issues by manually assembling the search results into some sort of document that can be stored and accessible to the user on multiple environments—such as a word-processor document. However, if the user saved their search results on a document, the user must manually re-type the URL or search again to review the full result contained in the webpage. Manual compilation of the results is prone to human errors such as typos.

Some curation platforms, for example, Pinterest and Evernote, let users search and save results within information that resides in its respective systems (i.e. stored by one of its users). However these systems do not allow a user to do further searching outside of its niche content (i.e. cannot search the world wide web) and contextually save the user desired search results without leaving their application environment and/or requiring a separate application/widget/browser plug-in. Therefore, to augment results from these curation platforms, the user has to exit the curating website, go to a search engine website, enter a search query and copy any desired search results back into the curation platform. In addition to the complexity of installations for a user with a personal computer, a user without a personal computer (e.g. users who rely on public computers at libraries or schools to conduct research) cannot use installation-based environments like the “Pinterest Pin It” button or “Evernote Web Clipper” (as public computers prohibit personal application installation).

Given these problems, there is a need for a service that simplifies the way in which information from various sources can be brought together in an integrated computer system that is accessible from any device that can access the internet to enable a user to search, curate, contextualize, contribute and engage with information about a research topic in one place.

### BRIEF DESCRIPTION OF THE DRAWINGS

FIG. 1 is an illustration of a representative computer system that can be used to implement the disclosed technology;

FIG. 2 shows a portion of an exemplary web page presented by the computer system into which a user can enter a search query;

FIG. 3 illustrates a number of cards that are created from retrieved search results in accordance with one embodiment of the disclosed technology;

FIG. 4 illustrates how a card can be added to a board in order to save a search result and, if permitted, to allow collaboration on the information presented in the card in accordance with one embodiment of the disclosed technology;

FIG. 5 illustrates a number of boards that are the retrieved search results from internal search engine in accordance with one embodiment of the disclosed technology;

FIG. 6 illustrates one embodiment of how additional searching can be performed from within the service in order to add additional information to the board;

FIG. 7A illustrates how a user can select to edit a card in accordance with one embodiment of the disclosed technology;

FIG. 7B illustrates how a card can be edited to add a user's notes (context) in accordance with one embodiment of the disclosed technology;

FIG. 8 illustrates how multi-media or other rich-media content can be added to a card in accordance with an embodiment of the disclosed technology;

FIG. 9 shows how cards on a board can be sorted by color (or other categorizing metadata) in accordance with an embodiment of the disclosed technology;

FIG. 10 shows how boards in a user's account can be categorized as public or private in accordance with an embodiment of the disclosed technology;

FIG. 11 illustrates how a board and cards can be viewed on a mobile computing platform

FIG. 12 shows one process for allowing a user to search and curate search results in accordance with an embodiment of the disclosed technology;

FIG. 13 shows one process for allowing a user to query a search engine in accordance with an embodiment of the disclosed technology;

FIG. 14 shows one process for allowing a user to update search results from within the search/curation service of the disclosed technology; and

FIG. 15 shows one process for analyzing content to be added to a card in accordance with an embodiment of the disclosed technology.

### DETAILED DESCRIPTION

To address the problems discussed above, the technology disclosed herein is a computer system or cluster of computers that can query, organize and store rich-media research information for a topic in a simplified manner. One embodiment of the disclosed technology allows the creation and storage of search metadata in a manner that does not require special programs or plug-ins to a user's computer. In addition, as will be described in further detail below, multi-media or other content can be easily added by the user (i.e. not derived from search) to a board containing search metadata without requiring that a user be skilled in the art of computer programming. Any board can be stored in a manner that is privately or publicly accessible so that others can contribute to the information contextualized within a board.

By bringing search engine functionality and curation platform functionality together in a single place, research efforts are enhanced by building upon the cycle of research/curate/learn/update/enhance/contextualize/and connect which represent the actions by humans to conduct search online as well as document their experience in engaging with the information in real life. Furthermore, the topically organized, curated answers to a series of questions are presented in context of research in a manner that creates greater value to a subsequent researcher by helping them formulate additional questions to the answers they discover.

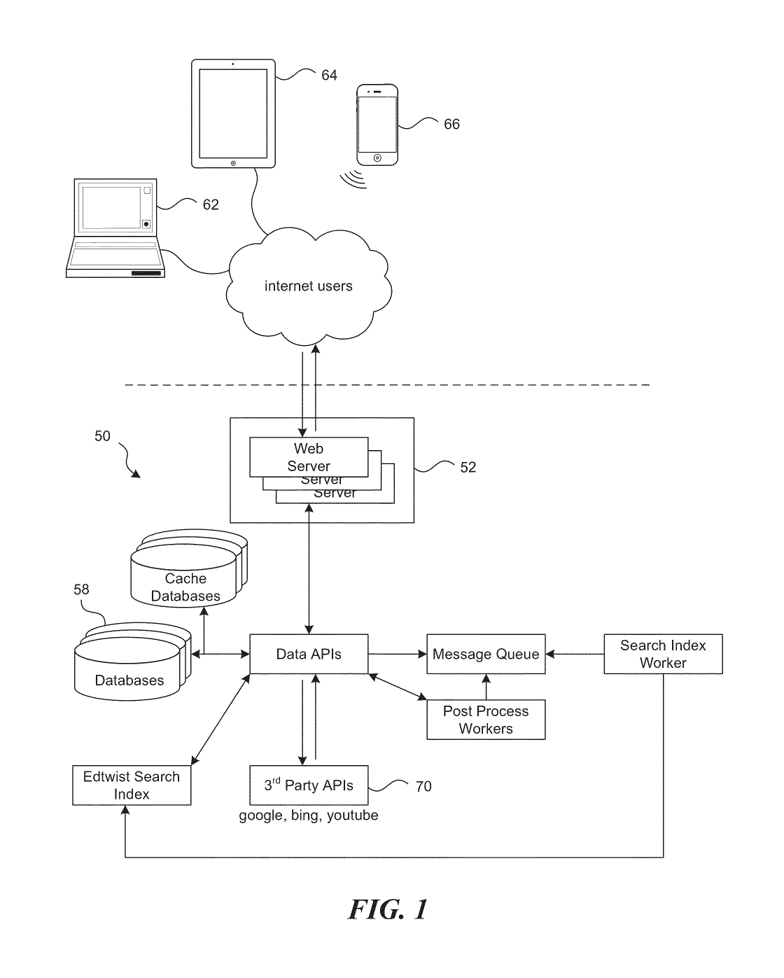

FIG. 1 illustrates a representative computer system 50 that is programmed to enable the query, storage and curation of user-input information along with search results that comes from the Internet (e.g. World Wide Web) in accordance with the disclosed technology. The computer system 50 includes one or more programmed processors, such a number of web servers 52 that are configured to execute program instructions stored on a non-transitory, computer readable media (e.g., CD ROM, hard drive, SSD, flash memory, USB memory stick or the like) or received on a computer network such as the Internet. The computer system 50 includes volatile and non-volatile memory for storing records of search results in a suitable format. In one embodiment, records of search results are stored in a database 58.

In the embodiment shown, the computer system 50 is a cluster of Internet-based computers that are accessible by a number of users through their computing devices such as laptops or desktop computers 62, other portable computing devices 64 such as iPads, slate computers or the like. Alternatively, a user can access the computer system 50 through a mobile computing device 66 such as a smart phone, PDA etc. The computer system 50 is also in communication with one or more search engines 70 and other resources/web servers that are available through the Internet.

As will be explained in further detail below, the computer system 50 is programmed to allow users to access the computer system 50 with a browser program (Internet Explorer™, Firefox™, Chrome™ etc.) or a mobile application. Using a browser or mobile application, a user can enter search queries and curate records of the search results retrieved in response to those search queries. Multi-media content and/or comments can be added to the search results and if permitted, comments or additional content that are provided by other collaborators.

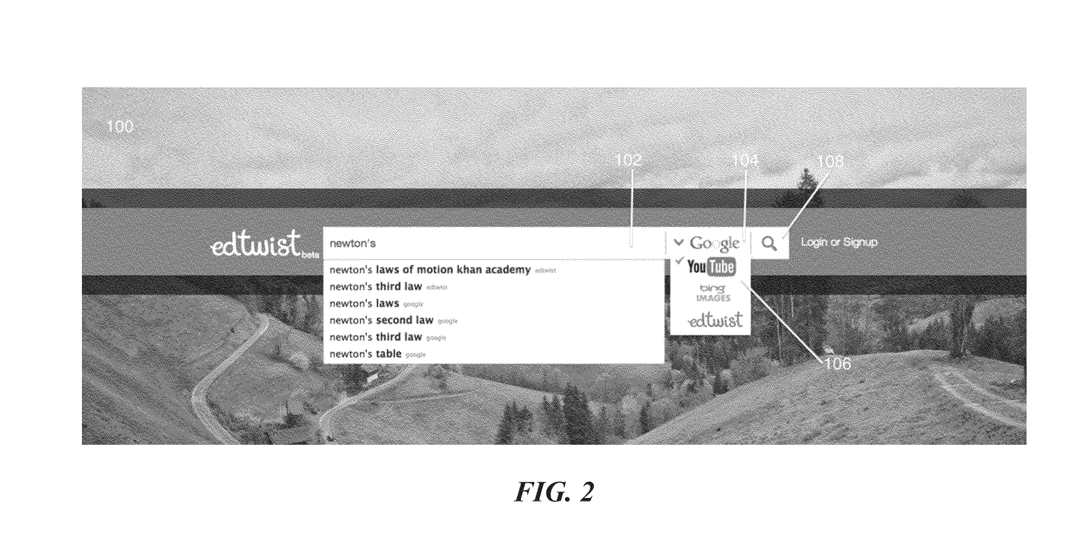

FIG. 2 shows one example of a web page 100 presented by the computer system 50 when the user accesses a website (e.g. www.edtwist.com) in accordance with the disclosed technology. The web page 100 preferably includes a search bar 102 into which a user can enter a search query. The currently selected search engine 104 is shown near the search bar 102. In one embodiment, clicking or hovering on the currently selected search engine 104 causes the web page 100 to present a drop down menu 106 or other list of additional search engines that can be selected by the user to perform a search on their entered search terms. The search engines can be commercial web search engines that index the entire world wide web(e.g. Google, Bing, Yahoo), niche content search that searches specific domains (e.g. YouTube, Tumblr, Amazon, Yelp) or an internal search engine that searches content indexed internally by computer system 50. Alternatively, a user can select to search the information of other users that is stored by the computer system 50. A button 108 or other control is selectable by the user to begin the search. In one embodiment, the search query remains in the search bar 102 until the user changes it, thereby allowing the user to run the same search query on different search engines without having to re-enter the search terms.

Upon selection of the button 108 or performing some other command or gesture, the user's browser program transmits the entered search terms to the computer system 50 that in turn forwards the search terms to the selected search engine via its application program interface (API). In one embodiment, the computer system 50 first searches a local cache of search results to see if a similar search has been previously performed and if not, then the search terms are sent to the search engine.

After sending the search terms to the search engine, the search engine returns search results to the computer system 50 through its API. The search results contain meta-data for each of a number of search results. The meta-data may include the IP address of the result, the URL of the web page with the result, a snippet or short description about the result, one or more photos from the website along with their image size or resolution and any keywords included in the website. The particular meta-data provided for each result is dependent on the particular search engine used for the search.

For each hit in the search results, the computer system 50 creates a “card,” which is a container that displays an individual piece of information with the added functionality such as a control which allows for the curation of the item (enabling user to add the search result into a collection of search results or other information that is referred to herein as a “board”). The card contains an individual search result. In the embodiment shown, each card is created to show a title, a snippet and if available, an image or video thumbnail from the referenced web page of the result. In addition, each card is given an internal reference number by the computer system 50 (e.g. a URL for the card) that distinguishes it from other cards. Instructions for rendering the cards are sent to the user's browser program. The user's browser program is programmed to determine when the user has scrolled some of the cards off their screen. At this time, the browser program signals the computer system 50 and the computer system either sends a request for more search results from the search engine or if additional search results were previously obtained, generates instructions to present additional cards on the user's screen.

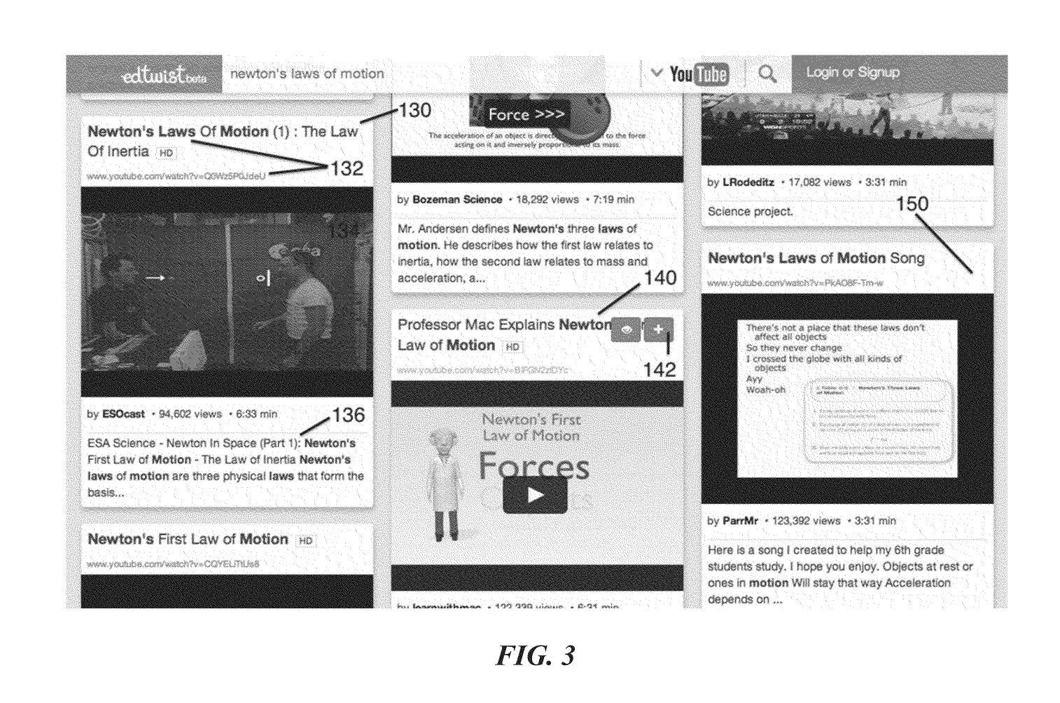

FIG. 3 illustrates one embodiment of a web page presented by the computer system 50 to present the results of a search. In one embodiment, the computer system 50 presents a number of cards 130, 140 and 150 each of which corresponds to a corresponding search result that was returned from the search engine. In the embodiment shown, the cards are generally rectangular on the display screen, although it will be appreciated that other shapes, sizes and colors could be used. In one embodiment, each card contains a title of the resource identified by the search result, its URL and a representative image obtained from the resource. For example, if the resource is a website directed to Newton's Laws of Motion, the card 130 includes a title and URL 132 obtained from the website, an image 134 and a snippet 136 that briefly describes the content referenced by the search result. The particular image shown can be selected from the meta-data provided by the search engine. If permissible, these images may be switched out for other images such as by giving the user a choice to choose or upload an image of their liking. In addition, computer system 50 is capable of programmatically detecting if the user is accessing the computer system 50 with a high resolution display, then an image with the highest resolution may be selected. Alternatively, if the user is accessing the computer system 50 with their mobile phone, then a lower resolution image may be selected to conserve bandwidth. In the example shown, card 140 includes a control 142 that when selected by the user, allows the search result to be saved by adding the card to a board. In one embodiment, the computer system 50 includes code along with the description of each card that will create the control 142 on the card. The code causes the user's browser to signal the computer system when the control 142 is activated in order to present additional dialog boxes in which the user is asked if they want to add the card to a collection of search results (e.g. a board).

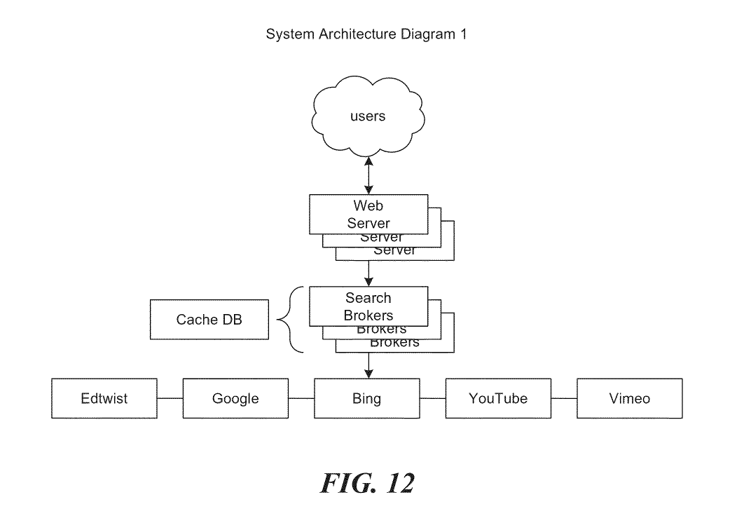

The following describes a series of steps performed by the computer system 50 to allow a user to both search and curate answers to search queries within a single service. As shown in FIG. 12, the computer system 50 downloads program code to the user's browser program when the user accesses the website of the computer system 50.

The user then interacts with the web pages produced by their browser to input a search query. The user enters search terms (e.g. “tree frog”) in a search bar and selects a search engine (e.g. Google). The user then selects or otherwise activates the “search” control 108 on the web page to start the search process.

Upon activation of the control 108, the browser program on the user's device forwards the search terms to web servers that validate and then forward to search brokers that are operating on the computer system 50. The search brokers package the search terms in a manner dictated by the API of the selected search engine. The search brokers then forward the search terms to the API of the selected search engine and check an internal cache to determine if search results that were obtained by another user of the system would satisfy the search. In one embodiment, the internal and external searches are performed in parallel.

In one embodiment, the search brokers on the computer system 50 are programmed to do inline-lexing to see if a pattern match finds any in-line search engines that the user has input. For example, if a query looks like this, “google:tree frog,” the search broker program will see that the term “google” exists before a colon “:” followed by the query “tree frog.” This can work for any search engine such as “bing:tree frog,” “youtube:tree frog.” Any in-line search engines that are detected take precedence over any search engine that may have been selected by the user in the search toggle. For example, if the user has selected “Google” in the search engine toggle but inputs “youtube:tree frog,” then the system will query and render search results from YouTube™ and not Google™.

The computer system 50 sends the query to the selected third-party search engine APIs. Responses are rendered into cards by web servers and sent to the user. One embodiment of a search result is illustrated in FIG. 3.

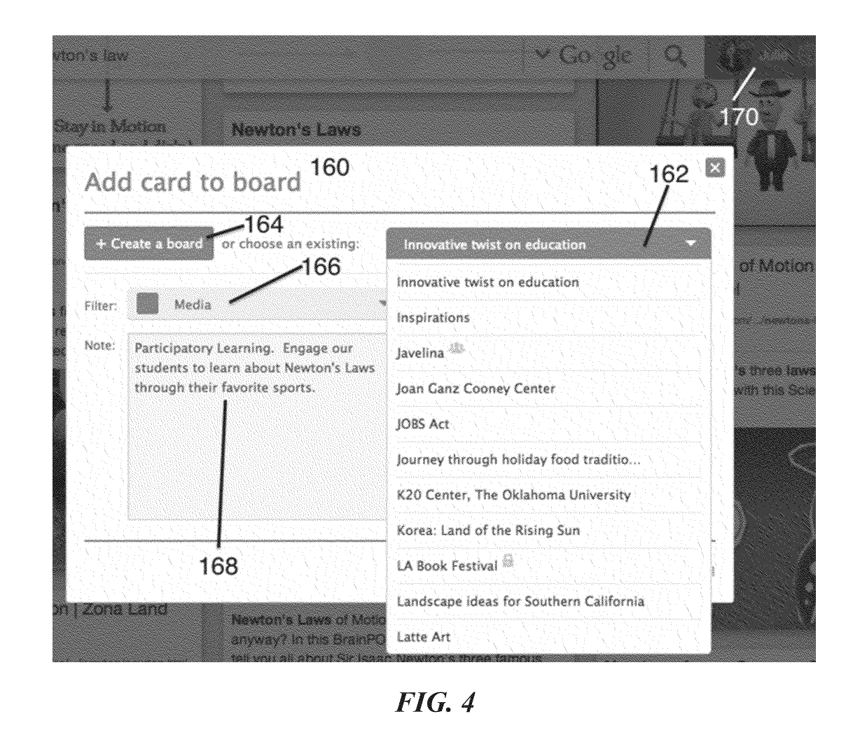

FIG. 4 shows further detail of a single card and how the card can be contextually added to a collection of search results that are curated by the user. In the embodiment described herein, such collections are referred to as boards. In one embodiment, selection of the control 142 (FIG. 3) causes the user's browser program to present a dialogue box 160 into which the user can enter further details about the card. The dialog box 160 shows a list of boards 162 to which the user can add the card. Previously defined boards are displayed in a scroll down list for the user. Alternatively, the user can create a new board by selecting a control 164. Colors or other identifiers for a card used to add the card on the board can be selected from a drop down list 166. As will be described in further detail below, card colors can be used to sort cards by priority, topic, date posted or other criteria. Finally, a dialog box 168 allows a user to add a note to a card that can be viewed when the user views the card on a selected board. Other meta-data stored for the card can include the search query and key terms, the board to which a card is to be added, the user who added the card to the board, the card title, note and filter or other rich media input by the user to the card.

The current user of the system is shown at 170. In one embodiment, users log on to the system with a user name and password. In another embodiment, the system is open to any user wishing to perform a search.

The card meta-data entered into the dialog box 168 is stored and can be recalled when the user selects the card in the board or the computer system 50 searches for related information. The meta-data for the card can include such things as information sent back from the search engine (e.g. the search engine meta-data), information obtained from visiting the source URL, information augmented by checking relationships and popularity.

The following describes one possible embodiment of the steps performed by the computer system 50 to add a card to a collection of cards (e.g. a board).

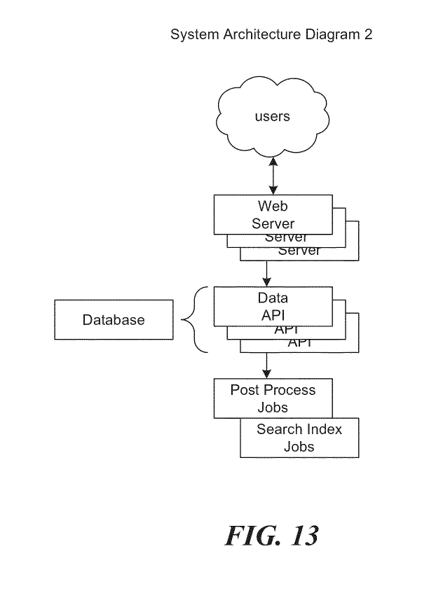

As shown in FIG. 13, the computer system 50 first detects when the user clicks, swipes or performs some other predefined gesture to add a card to a board. When detected, the computer system 50 forward a request to web servers to validate and forward the request to back end data APIs along with all relevant information, including the URL of the card that the user wants to add, the user id, board id and other relevant information that was provided in the dialog box 160.

The computer determines the URL of the card and an association between the card URL and a board is made along with other meta-data such as notes, descriptions, card color and search query used to surface the card. The association is stored in databases 58 that are part of the computer system 50 (See FIG. 1). Upon a successful write to the databases, the data APIs of the computer system 50 trigger post process jobs and search index jobs that are run in the background.

In one embodiment, the computer system 50 does not wait for jobs to finish but rather responds immediately to user that the resource was successfully saved. Post process jobs augment the information that the computer system 50 knows about the URL for the card. This is accomplished by checking an internal and/or external data source for meta-data about the URL and/or by visiting the site.

Once any additional information is obtained about the subject matter of the card, board meta-data and meta-data for all cards contained within the board are added into a searchable index. This includes:

a. Board:
i. Title
ii. Description
iii. Owner
iv. Board security: public or private

b. Card:
i. Title
ii. Description
iii. URL
iv. notes
v. augmented data such as thumbnail images, augmented content
vi. keywords
vii. query used to surface card from search engine
viii. related URLs

Any queries the user used to surface any cards in the board are also added into a separate search suggestions index.

The following are examples of data before post processing: A typical web url:

```
{
  __v: 0,
  _id: ObjecteId(“539387369f966cb39e3ce792”),
  createdOn: ISODate(“2014-06-07T21:42:14.692Z”),
  editedOn: ISODate(“2014-06-07T21:43:06.591Z”),
  meta: {
    displayUrl: “animals.nationalgeographic.com/animals/.../red-eyed-tree-
      frog/,”
    snippet: “Learn all you wanted to know about red-eyed tree frogs with
      pictures, videos, \nphotos, facts, and news from National
      Geographic.,”
    thumbUrl: “http://images.nationalgeographic.com/wpf/media-
      live/photos/000/006/cache/redeyed-tree-frog 683 600×450.jpg”
  },
  title: “Red-Eyed Tree Frog,”
  url: “http://animals.nationalgeographic.com/animals/amphibians/red-eyed-
      tree-frog/”
}
```

A typical video url:

```
{
  __v: 0,
  _id: ObjectId(“5397774268fea665b0300f6a”),
  createdOn: ISODate(“2014-06-10T21:23:14.168Z”),
  editedOn: ISODate(“2014-06-10T21:23:23.359Z”),
  imgMeta: {
    height: “360,”
    avgColor: “#393b18,”
    width: “480”
  },
  meta: {
    displayUrl: “www.youtube.com/watch?v=U7cChtwrXxl,”
    snippet: “http://Ojatro.com http://Ojatroblog.blogspot.com Red-eyed
      tree frogs have red eyes with vertically narrowed noses, a vibrant
      green body with yellow and blue ...,”
    thumbUrl: “//img.youtube.com/vi/U7cChtwrXxl/hqdefault.jpg”
  },
  title: “Red Eyed Tree Frog 01,”
  url: “http://www.youtube.com/watch?v=U7cChtwrXxl”
}
```

Post processing obtains information about the URL and adds to its definition. For some partnered sites, the information is provided upon request by the computer system 50. For non-partnered sites, a bot can be sent to visit the site, to crawl the web page indicated and retrieve information from the site. The following show how the URLs can be enhanced with information stored in the property “augmentMeta.”

An example of a web url:

```
{
  __v: 0,
  _id: ObjectId(“539387369f966cb39e3ce792”),
  createdOn: ISODate(“2014-06-07T21:42:14.692Z”),
  editedOn: ISODate(“2014-06-07T21:43:06.591Z”),
  augmentMeta: {
    data: {
      published: “None,”
      favicon_colors: “[{‘color’: [0, 0, 0], ‘weight’: 0.000244140625}, {‘color’:
        [252, 201, 4] ‘weight’: 0.000244140625}],”
      title: “Red-Eyed Tree Frog,”
      url: “http://animals.nationalgeographic.com/animals/amphibians/red-
        eyed-tree-frog/,”
      language: “English,”
      lead: “None,”
      cache_age: “86400,”
      offset: “None,”
      safe: “True,”
      images: “[{‘width’: 400, ‘url’:
        ‘http://animals.nationalgeographic.com/u/TvyamNb-
        BivtNwpvn7Sct0VFDulyAfA9wBcU0gVHVngC5gholC1aR3t3wObOv2-
          NaFw4aoM-sKNl7gT/’, ‘height’: 300, ‘caption’: None, ‘colors’: [{‘color’:
        [23, 30, 27], ‘weight’: 0.26025390625}, {‘color’: [67, 76, 56], ‘weight’:
        0.21044921875}, {‘color’: [174, 181, 177], ‘weight’: 0.1474609375},
        {‘color’: [118, 123, 100], ‘weight’: 0.14453125}, {‘color’: [157, 145, 105],
        ‘weight’: 0.116943359375}], ‘entropy’: 6.52267663337, ‘size’: 31138},
        {‘width’: 600, ‘url’: ‘http://images.nationalgeographic.com/wpf/media-
        live/photos/000/006/cache/redeyed-tree-frog 683 600×450.jpg’,
        ‘height’: 450, ‘caption’: None, ‘colors’: [{‘color’: [24, 31, 28], ‘weight’:
        0.2734375}, {‘color’: [131, 132, 106], ‘weight’: 0.224609375}, {‘color’:
        [184, 192, 186], ‘weight’: 0.198974609375}, {‘color’: [66, 75, 55],
        ‘weight’: 0.197509765625}, {‘color’: [220, 181, 67], ‘weight’:
        0.0400390625}], ‘entropy’: 6.501271470870023, ‘size’: 39989},
        {‘width’: 160, ‘url’: ‘http://images.nationalgeographic.com/wpf/media-
        live/graphic/map-red-eyed-tree-frog-160-20160-cb1273164322.gif’,
        ‘height’: 120, ‘caption’: None, ‘colors’: [{‘color’: [56, 108, 139], ‘weight’:
        0.646240234375}, {‘color’: [193, 145, 70], ‘weight’: 0.23095703125},
        {‘color’: [224, 234, 236], ‘weight’: 0.090087890625}, {‘color’: [248, 213,
        96], ‘weight’: 0.03271484375}], ‘entropy’: 2.4280361855822927, ‘size’:
        11120}, {‘width’: 160, ‘url’:
        ‘http://images.nationalgeographic.com/wpf/media-live/graphic/size-
        redeyedtreefrog-160-2852-cb1273164322.gif’, ‘height’: 90, ‘caption’:
        None, ‘entropy’: 0.733682406215398, ‘size’: 1502}, {‘width’: 100, ‘url’:
        ‘http://images.nationalgeographic.com/wpf/media-
        live/photos/000/004/cache/amazon-horned-frog 443 100×75.jpg’,
        ‘height’: 75, ‘caption’: None, ‘colors’: [{‘color’: [89, 101, 56], ‘weight’:
        0.472412109375}, {‘color’: [55, 58, 27], ‘weight’: 0.176513671875},
        {‘color’: [13, 11, 7], ‘weight’: 0.17236328125}, {‘color’: [149, 145, 101],
        ‘weight’: 0.115234375}, {‘color’: [212, 183, 147], ‘weight’:
        0.0634765625}], ‘etropy’: 6.019393619688084, ‘size’: 2715}],”
      embeds: “[ ],”
      description: “Many scientists believe the red-eyed tree frog developed its
        vivid scarlet peepers to shock predators into at least briefly
        questioning their meal choice. These iconic rain-forest amphibians
        sleep by day stuck to leaf-bottoms with their eyes closed and body
        markings covered.,”
      type: “html,”
      provider_name: “Nationalgeographic,”
      entities: “[{‘count’: 1, ‘name’: ‘Central America’}, {‘count’: 1, ‘name’: ‘South
        America’}, {‘count’: 1, ‘name’: ‘Mexico’}],”
      content: “<div>\n<p>Many scientists believe the red-eyed tree frog
        developed its vivid scarlet peepers to shock predators into at least
        briefly questioning their meal choice.</p>\n<p>These iconic rain-
        forest amphibians sleep by day stuck to leaf-bottoms with their eyes
        closed and body markings covered. When disturbed, they flash their
        bulging red eyes and reveal their huge, webbed orange feet and
        bright blue-and-yellow flanks. This technique, called startle coloration,
        may give a bird or snake pause, offering a precious instant for the frog
        to spring to safety.</p>\n<p>Their neon-green bodies may play a
        similar role in thwarting predators. Many of the animals that eat red-
        eyed tree frogs are nocturnal hunters that use keen eyesight to find
        prey. The shocking colors of this frog may over-stimulate a predator's
        eyes, creating a confusing ghost image that remains behind as the
        frog jumps away.</p>\n<p>Red-eyed tree frogs, despite their
        conspicuous coloration, are not venomous. They are found in tropical
        lowlands from southern Mexico, throughout Central America, and in
        northern South America. Nocturnal carnivores, they hide in the rain
        forest canopy and ambush crickets, flies, and moths with their long,
        sticky tongues.</p>\n<p>Red-eyed tree frogs are not endangered. But
        their habitat is shrinking at an alarming rate, and their highly
        recognizable image is often used to promote the cause of saving the
        world's rain forests.</p>\n</div>,”
      original_url:
        “http://animals.nationalgeographic.com/animals/amphibians/red-eyed-
        tree-frog/,”
      app_links: “[ ],”
      keywords: “{[‘score’: 55, ‘name’: ‘frogs’}, {‘score’: 40, ‘name’: ‘red-eyed’},
        {‘score’: 20, ‘name’: ‘tree’}, {‘score’: 18, ‘name’: ‘predator’}, {‘score’: 16,
        ‘name’: ‘nocturnal’}, {‘score’: 13, ‘name’: ‘coloration’}, {‘score’: 11,
        ‘name’: ‘eyes’}, {‘score’: 10, ‘name’: ‘forests’}, {‘score’: 10, ‘name’:
        ‘neon-green’} {‘score’: 10, ‘name’: ‘over-stimulate’}],”
      favicon_url:
        “http://images.nationalgeographic.com/wpf/sites/common/i/icons/favic
        on-cb1274471343.ico,”
      related: “[ ],”
      provider_display: “animals.nationalgeographic.com,”
      authors: “[ ],”
      provider_url: “http://animals.nationalgeographic.com”
    },
    type: “html,”
    medium: “None,”
    partner: “crawler”
  },
  imgMeta: {
    height: “450,”
    avgColor: “#716e56,”
    width: “600”
  },
  meta: {
    displayUrl: “animals.nationalgeographic.com/animals/.../red-eyed-tree-
        frog/,”
    snippet: “Learn all you wanted to know about red-eyed tree frogs with
        pictures, videos, \nphotos, facts, and news from National
        Geographic.,”
    thumbUrl: “http://images.nationalgeographic.com/wpf/media-
        live/photos/000/006/cache/redeyed-tree-frog 683 600×450.jpg”
  },
  title: “Red-Eyed Tree Frog,”
  url: “http://animals.nationalgeographic.com/animals/amphibians/red-eyed-
        tree-frog/”
}
```

An example of a YouTube URL:

```
{
  __v: 0,
  _id: ObjectId(“5397774268fea665b0300f6a”),
  augmentMeta: {
    partner: “youtube,”
    medium: “video,”
    type: “application/x-shockwave-flash,”
    video: {
      thumbs: “[{‘url’: ‘https://i1.ytimg.com/vi/U7cChtwrXxl/
        default.jpg’, ‘width’: 120, ‘time’: ‘00:00:41.500’, ‘yt$name’:
        ‘default’, ‘height’: 90}, {‘url’: ‘https://i1.ytimg.com/vi/
        U7cChtwrXxl/mqdefault.jpg’, ‘width’: 320, ‘yt$name’:
        ‘mqdefault’, ‘height’: 180}, {‘url’: ‘https://i1.ytimg.com/vi/
        U7cChtwrXxl/hqdefault.jpg’, ‘width’: 480, ‘yt$name’:
        ‘hqdefault’, ‘height’: 360}, {‘url’: ‘https://i1.ytimg.com/
        vi/U7cChtwrXxl/sddefault.jpg’, ‘width’: 640, ‘yt$name’:
        ‘sddefault’, ‘height’: 480}, {‘url’: ‘https://i1,ytimg.com/vi/
        U7cChtwrXxl/1.jpg’, ‘width’: 120, ‘time’: ‘00:00:20.750’,
        ‘yt$name’: ‘start’, ‘height’: 90}, {‘url’: ‘https://i1.ytimg.com/vi/
        U7cChtwrXxl/2.jpg’, ‘width’: 120, ‘time’: ‘00:00:41.500’,
        ‘yt$name’: ‘middle’, ‘height’: 90}, {‘url’: ‘https://i1.ytimg.com/
        vi/U7cChtwrXxl/3.jpg’, ‘width’: 120, ‘time’: ‘00:01:02.250’,
        ‘yt$name’: ‘end’, ‘height’: 90}],”
      rating: {
        numDislikes: “5,”
        numLikes: “66”
      },
      stats: {
        favoriteCount: “0,”
        viewCount: “41436”
      },
      src:
        “//www.youtube.com/v/U7cChtwrXxl?version=3&f=
        videos&d=ASIHO43dDsmjlnYHQQLAfxwO88HsQipE1a
        8d1GxQnGDm&app=youtube gdata,”
      title: “Red Eyed Tree Frog 01,”
      duration: “83,”
      views: “41436,”
      id: “U7cChtwrXxl”
    }
  },
  createdOn: ISODate(“2014-06-10T21:23:14.168Z”),
  editedOn: ISODate(“2014-06-10T21:23:23.359Z”),
  imgMeta: {
    height: “360,”
    avgColor: “#393b18,”
    width: “480”
  },
  meta: {
    displayUrl: “www.youtube.com/watch?v=U7cChtwrXxl,”
    snippet: “http://Ojatro.com http://Ojatroblog.blogspot.com
        Red-eyed tree frogs have red eyes with vertically narrowed noses,
        a vibrant green body with yellow and blue ...,”
    thumbUrl: “//img.youtube.com/vi/U7cChtwrXxl/hqdefault.jpg”
  },
  title: “Red Eyed Tree Frog 01,”
  url: “http://www.youtube.com/watch?v=U7cChtwrXxl”
}
```

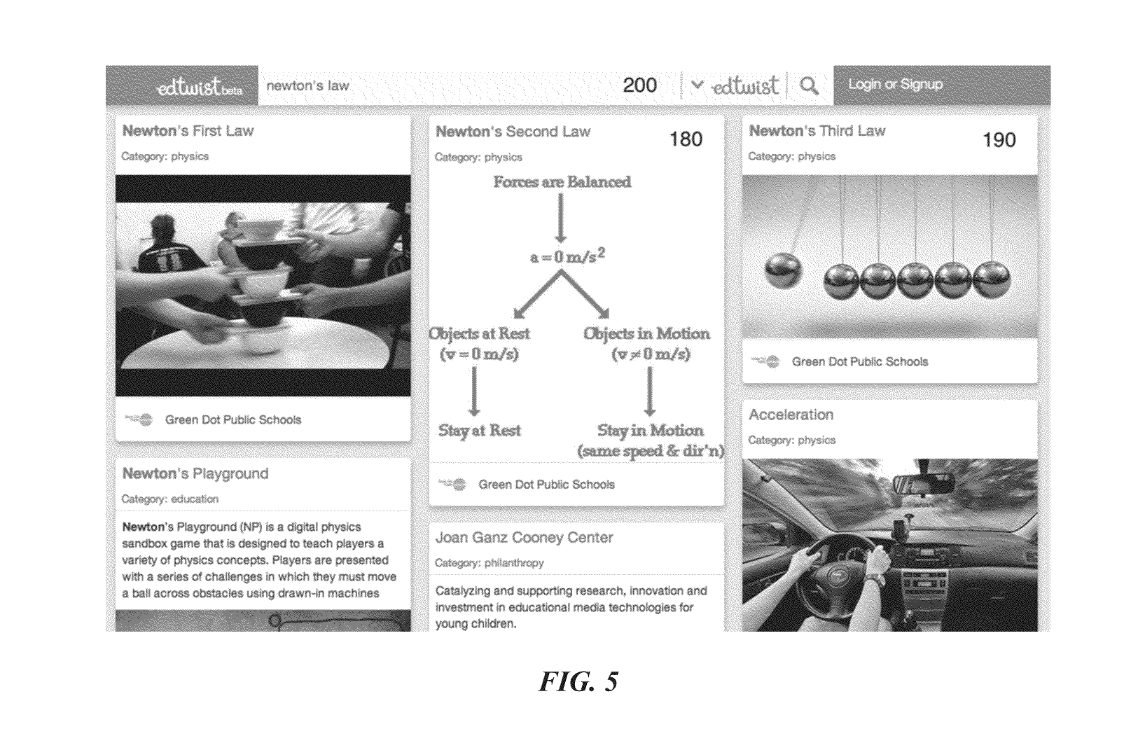

FIG. 5 illustrates a portion of a web page presented by the computer system 50 that represents search results in the form of boards 180 and 190 in response to a search query conducted on an internal search engine. In the embodiment shown, the boards are presented in a generally rectangular shape. However other shapes, sizes or colors could be used.

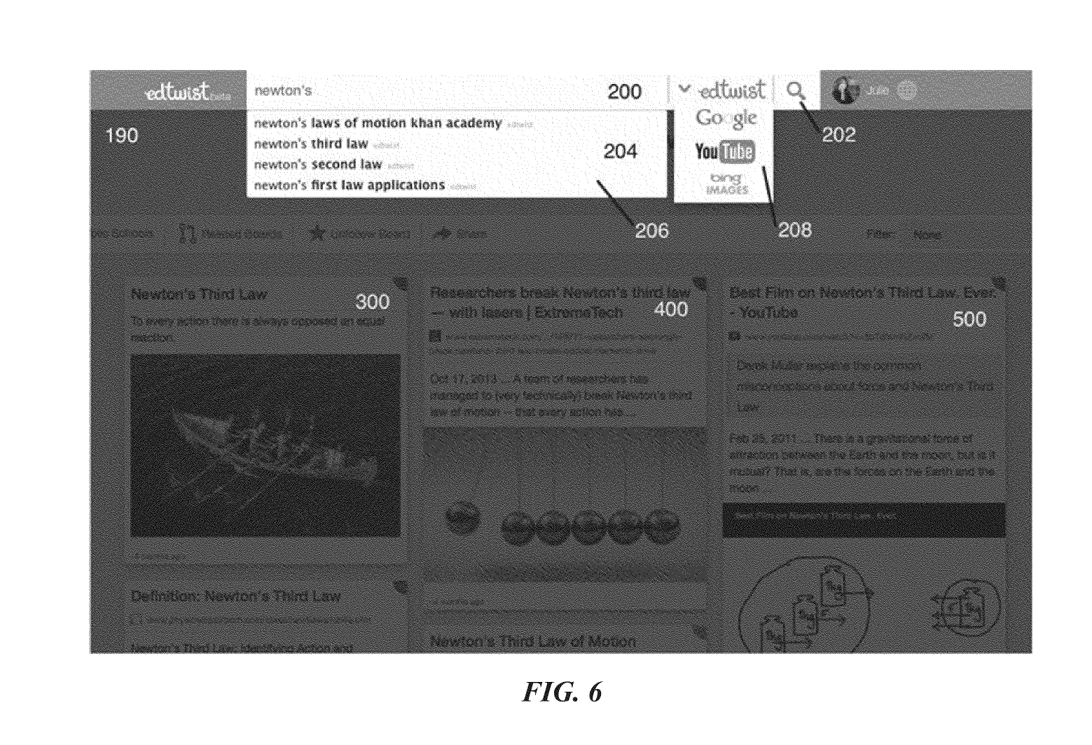

As shown in FIG. 6, one feature of the disclosed technology is that a user can augment the search results from within the service that creates the board. That is, the web page showing the board with cards 300, 400 and 500 includes the search bar 200, into which the user can enter additional search terms. Upon selecting or activating a search button 202, the browser program on the user's computing device transmits the search terms to the computer system 50 that, in turn, forwards the search terms to the search eengine or searches its local cache for search results matching the search terms.

In one embodiment, the computer system 50 presents suggested search terms as the user enters the letters of their own search terms. In one embodiment, the browser program on the user's computing device is programmed to submit each letter/symbol of a search term to the computer system 50 as it is entered. The computer system 50 forwards the letter/symbol to the search engine and receives search suggestions 204 from the search engine that are sent the browser program and displayed in a text box 206. In one embodiment, the computer system 50 also does a search for matching search terms on its own database of search terms associated with previously defined boards and/or cards. Any matching results are forwarded to the user's browser program and displayed. Therefore, the user is apprised of the fact that other users of the system have researched similar topics.

In the example shown in FIG. 6, a user who enters the search term “newton's” in the search bar 200 is shown suggestions in a textbox 206. The suggestions in the textbox are obtained from both the selected search engine and from the computer system 50 searching for search terms associated with other cards/boards in the database. In the embodiment shown, each suggestion is displayed with an indication of where the information is located. If the user likes a suggestion, they can click on, or select, a suggestion and the computer system 50 will either search those terms on the selected search engine or show the boards with the corresponding suggested search terms.

The following pseudo-code describes one series of steps performed to allow a user to augment the information in a board from within the service that creates the board.

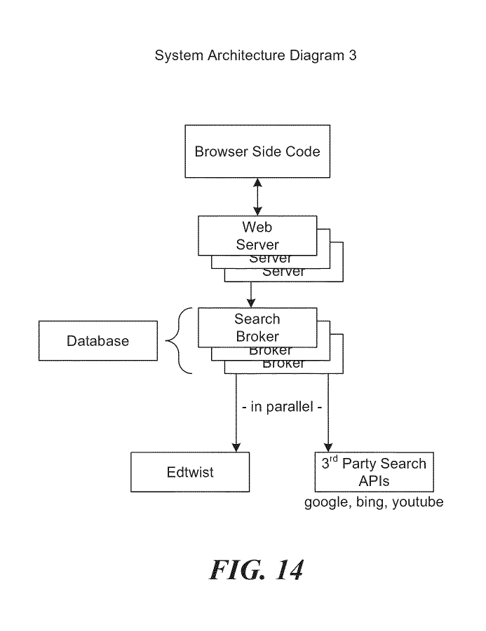

As shown in FIG. 14, the user's browser is programmed to bind key up events when the search input box is active in a board so that on every key up event, an autocomplete or type ahead function is triggered. Keys entered are detected and sent to the computer system 50. If the function does not find an internal cache that can fulfill the query, then the computer system 50 send the detected key to the selected search engine.

The computer system 50 determines parameters that need to be forwarded to the search engine including the detected query such as the letters “tr” and the external search engine the user has selected.

The computer system 50 first checks an internal cache to see if a cache record can fulfill the request. If found, then the computer system 50 immediately responds, else the detected search keys are sent to an internal search engine and the selected external search engine in parallel.

For example, if a user types “tr” in the search bar, the internal search engine may suggest “travel culture” or “tree frog.” If the external search engine is “Google,” the computer system 50 receives what the Google API sends back such as “translate,” “Travelocity” or “true detective.”

The computer system 50 amalgamates the results so that both internal and external search engine suggestions are shown and sent to the user's browser along with an indication of where each suggestion is from.

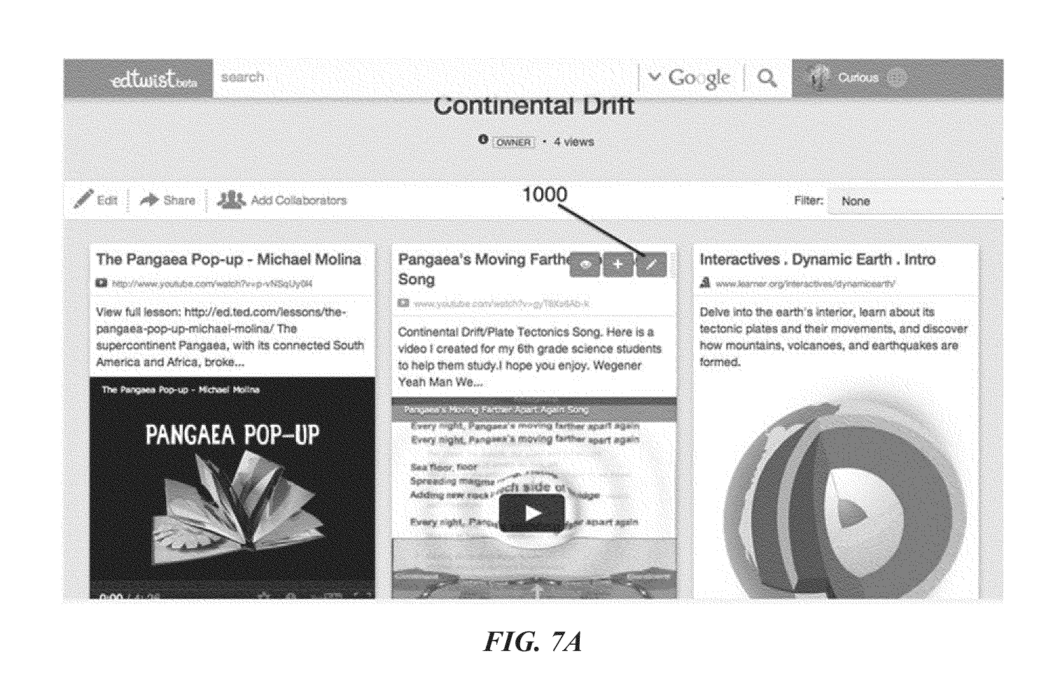

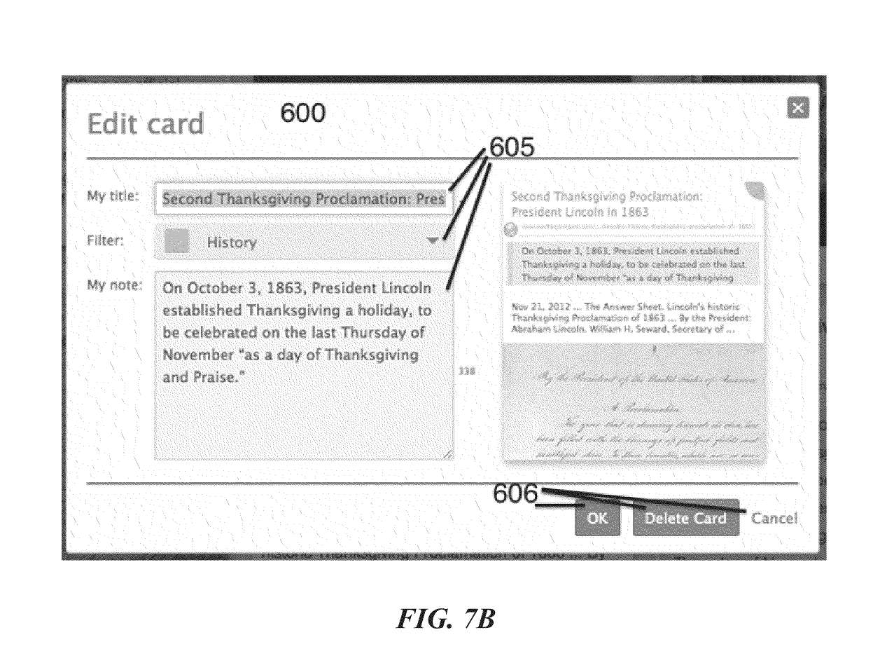

As best shown in FIG. 7A each card in a board includes a control 1000 (shaped like a pencil in the embodiment shown but is not limited to this shape, color or size) that allows a user to edit the card by adding comments, URLs, multi-media content, etc. In one embodiment, a control on the card appears when the user places a pointing device over a corner of the card. In addition to a pointing device, any user action mechanism such as hover state, swipe, touch or hand-gesture can be used. The user can add meta-data such as a comment to the card with a dialog box that is opened when the user selects the control as shown in FIG. 7B.

FIG. 7B illustrates how a dialogue box 600 is presented by the user's browser program that allows the user to edit meta-data information associated with a card. Controls 605 allow a user to change meta-data identifying the card such as the card title, card notes accompanying the card and the color of the card. Controls 606 are provided for the user to save the changes to the card, cancel the operation or delete the card entirely.

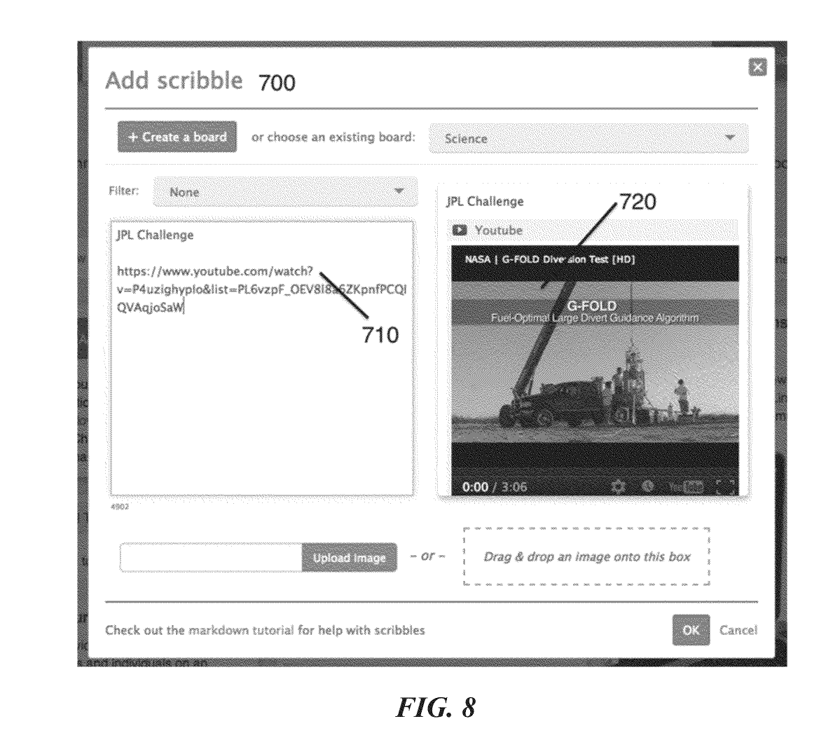

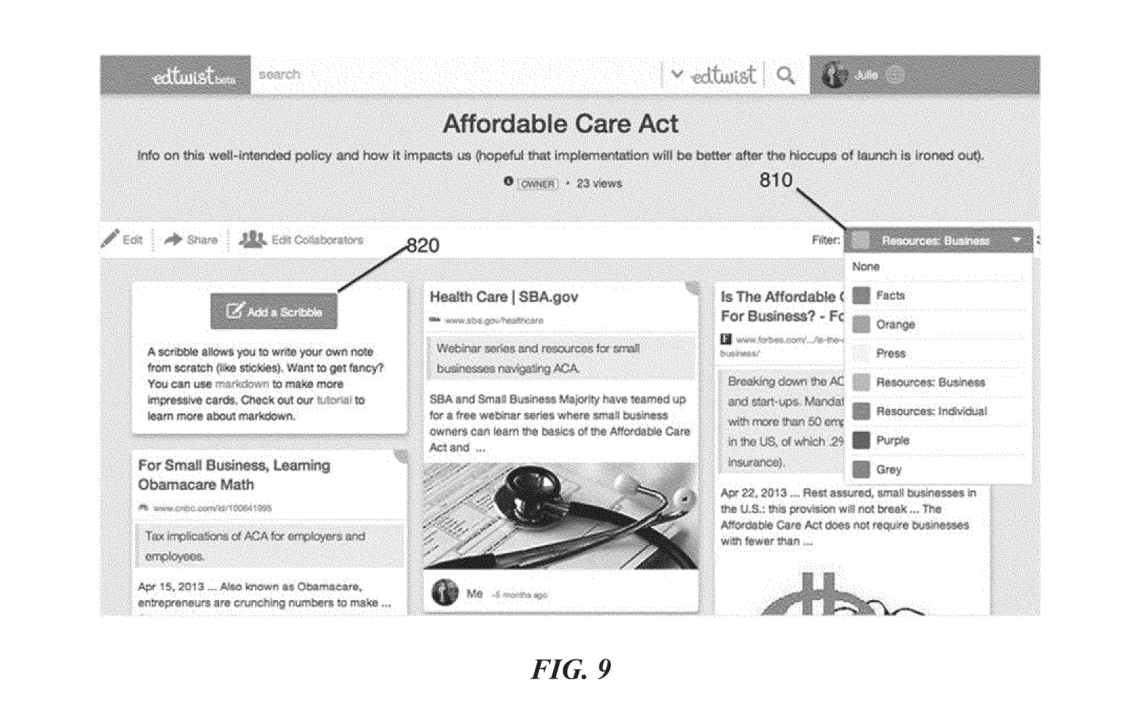

FIG. 8 illustrates how multi-media content can be added by a user to a board without a search. In the example shown, a dialog box 700 is presented when a user selects an “Add a Scribble” control 820 (See FIG. 9) in search results page or in a board. The user can add information that user has such as text, image and rich-media link to a video clip 710, a music file, a web page, an image, table, code segment or other content to the Scribble. In one embodiment of the disclosed technology, the computer system 50 analyzes the inserted link and determines what type of content is being added. For example, if the computer system 50 sees the words “YouTube” in the URL pasted into the card then it knows that it should add an embedded video player 720 to the card so that the referenced video can play in the card without taking a viewer to the YouTube website. In one embodiment, the computer system 50 uses converters to convert information entered into the dialog box 700 into the appropriately styled HTML that will be presented when the card is rendered by a browser or to find the appropriate player for the embedded content. In one embodiment, the converter is a customized markdown converter.

The following shows one series of steps performed by the computer system 50 to allow the user to add their own knowledge or input to the information contained into a board.

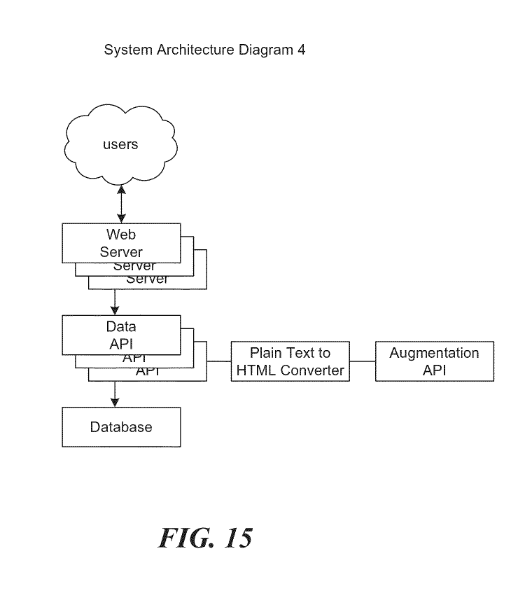

As shown in FIG. 15, the computer system 50 detects that a user has selected the Add a Scribble control 820 (See FIG. 9) from a page that shows cards generated in response to a search or within a board.

The computer system 50 receives the text that was inserted into a dialog box within a control presented upon detection of the Add a Scribble control 820 (See FIG. 9).

The computer system 50 sends the text to a customized plain text to html converter that is capable of converting any specific text formatting into html. This can be accomplished using a plain-text to html syntax conversion language whereby
a. The converter detects specific pre-defined plain text formatting to be converted into html. For example, if the text that is input by the user is “**hello**” then the converter will convert this text into the following html “<strong>hello</strong>.”
b. If a URL is detected, the converter is coded so that it will query an internal augmentation API for metadata about the URL. The augmentation API performs pattern matching to determine if the text entered represents a URL to another web site. In addition, the API looks at a database of previously crawled data to obtain information about the web site represented by the link such as its title, description, images and appropriate player (if needed).
c. If any meta-data is received for the URL, then a site preview for the URL will be generated. A site preview is html formatted in a certain way so that it includes the URL domain, URL title, URL description, thumbnail images and possibly, embedded video player or other rich media.
d. If no meta-data is received from the augmentation API, then the customized converter will fall back to the default behavior of creating an HTML anchor tag for the URL. Typically this default fallback behavior happens when an invalid link is detected or a URL that is not publicly accessible.

The computer system 50 then store the original text of the user input, the converter generated HTML, board id and user id to the database and responds to the user on status (i.e. success/fail).
An example of customized converter that augments with embed video player.
   Example of user input text:
   “**hello** https://www.youtube.com/watch?v=eNFfK5uo6D0”
   Example of converted html:
“<div class=“snippet”><p><strong>hello</strong></p><div class=“site-preview” data-markdownid=“5EZUyynD2K”“=””><div class=“provider”><iframe width=“640” height=“390”
src=“//www.youtube.com/embed/eNFfK5uo6D0” frameborder=“0” allowfullscreen></iframe></div></div><p></p></div>”
An example of customized converter that augments with a web page preview (without an embedded video player).

Example of user input text: “**hello** http://www.nasa.gov/press/2014/june/new-nasa-space-observatory-to-study-carbon-conundrums/index.html#.U5owq41dW-I”

Example of converted html: <div class=“snippet”><p><strong>hello</strong></p><div class=“site-preview” data-markdownid=“5GDP39dUQA”><div class=“provider”><img class=“provider-favicon” src=“http://www.nasa.gov/favicon.ico”><a class=“provider-display” href=“http://www.nasa.gov/press/2014/june/new-nasa-space-observatory-to-study-carbon-conundrums/”>Nasa</a></div><div class=“info”><div class=“title”><a href=“http://www.nasa.gov/press/2014/june/new-nasa-space-observatory-to-study-carbon-conundrums/”>New NASA Space Observatory to Study Carbon Conundrums</a></div><div class=“desc”><hr>NASA's first spacecraft dedicated to measuring carbon dioxide levels in Earth's atmosphere is in final preparations for a July 1 launch from Vandenberg Air Force Base, California.</div><div class=“site-preview-thumb”><a href=“http://www.nasa.gov/press/2014/june/new-nasa-space-observatory-to-study-carbon-conundrums/”><img class=“lazy” data-original=“http://www.nasa.gov/sites/default/files/pia17800-full.jpg”src=http://www.nasa.gov/sites/default/files/pia17800-full.jpg style=“background-colonrgb(9,16,9); height:342px; “></a></div></div></div><p></p></div>

FIG. 9 illustrates a sample web page of a board presented by the user's browser program. The web page shows a number of cards and a control 810 that allows the user to view cards by filter color. In the example shown, the user is selecting to view those cards that are added to the board with a green color filter. The control includes a drop down list of other card colors that can be selected by the user to sort cards of a different color. If there are more cards than will fit onto a single screen, the screen can be scrolled to view additional cards. Alternatively, the cards may be re-sized to fit more cards on the screen at a single time. Colored cards allow a user to easily sort cards by priority or topic. In addition to color, letter codes, numeric codes, date codes or other identifiers can be used to categorize cards added to a board.

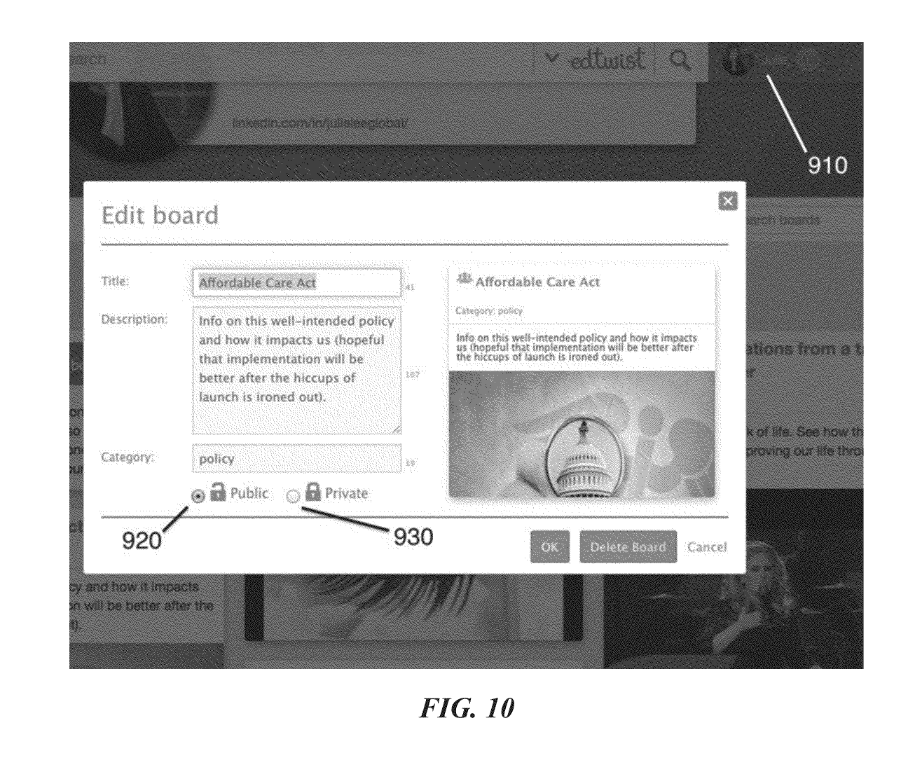

FIG. 10 illustrates a web page presented by the user's browser that allows a user to view their boards. The web page shows a photo 910 of the user or their avatar. In addition, the web page shows a list of the user's private and public boards. A control 920 allows a user to add a board to their public collection of boards. A control 930 allows a user to add a private board to their collection. Also shown are snapshots of all the user's private and public boards. Selecting any of the snapshots representing a board allows the user to navigate to the board selected.

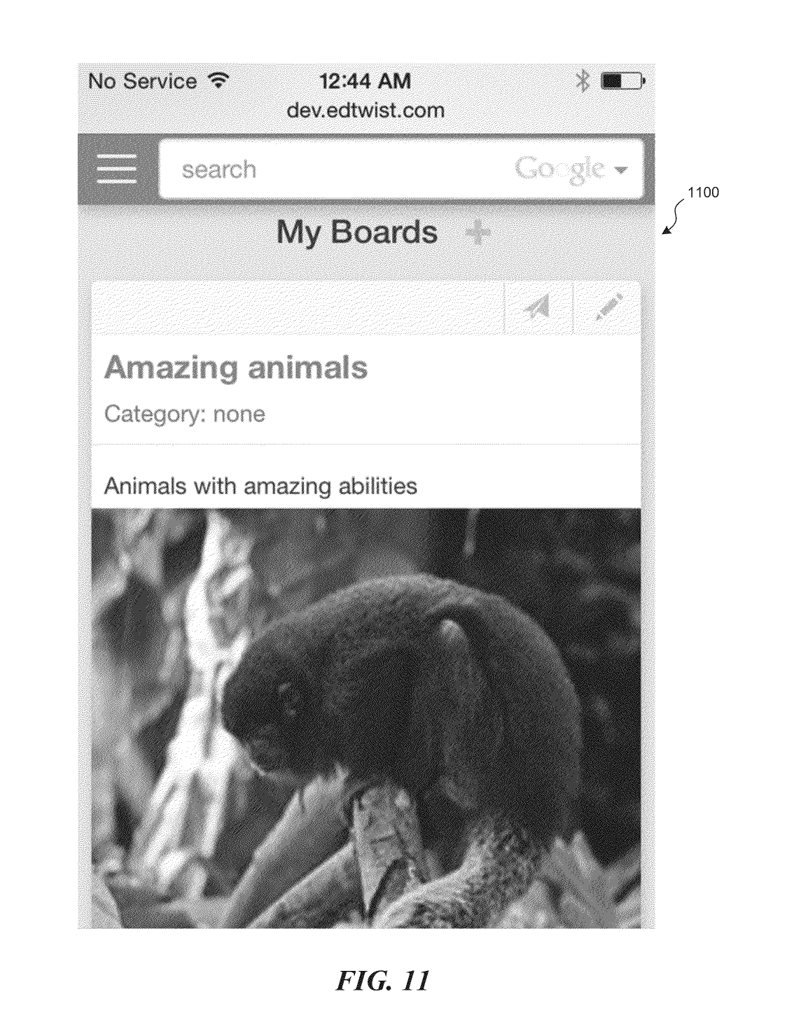

FIG. 11 illustrates a sample screen 1100 that is viewable on a user's mobile computing device such as their smart phone. A user interface on the mobile computing allows the user all the functionality described above (e.g. search topics, curate results, perform additional searching, add comments etc.)

From the foregoing, it will be appreciated that specific embodiments of the invention have been described herein for purposes of illustration, but that various modifications may be made without deviating from the scope of the invention. Accordingly, the invention is not limited except as by the appended claims.

I/We claim:

1. A computer system for storing collections of information on topics, comprising:
a processor configured to execute program instructions that cause the processor to:
present a user interface that is configured to receive selections of one or more cards to be added to a collection that holds information about a topic, wherein each card contains information about the topic that is obtained from an external search engine that indexes the world wide web, information obtained from other users of the computer system or information provided by the user;
wherein the user interface further includes a search mechanism for receiving one or more search terms from the user and performing additional searching about the topic from within the user interface; and
a memory for storing collections of cards.

2. The computer system of claim 1, wherein at least one card in the collection is created from an internet search result and includes a control that is selectable by the user to add the card to the collection.

3. The computer system of claim 1, wherein at least one card in the collection is derived from a collection of another user of the computer system.

4. The computer system of claim 1, where at least one card in the collection stores information received from another user about the topic.

5. The computer system of claim 1, wherein at least one card in the collection stores information from the user about the topic.

6. The computer system of claim 1, wherein the processor is configured to execute instructions that present suggestions to the user when a search term is being entered, wherein the suggestions include search terms from other collections of cards that are stored in the memory.

7. The computer system of claim 1, wherein the processor is configured to execute instructions to receive an indication of a selected search engine from a number of internal and third-party search engines and to transmit the received search terms to the selected search engine.

8. The computer system of claim 1, wherein the processor is configured to execute instructions that operate a converter that converts plain text into HTML and includes relevant site description, site title, site images, site icons and rich-media such as embedded video player and embedded documents when a url is detected.

9. The computer system of claim 1, wherein the processor is configured to execute instructions that display the collection of cards on a web page.

10. The computer system of claim 1, wherein the processor is configured to store meta-data about a card that includes search terms associated with the card.

11. A computer system for storing collections of information on topics, comprising:
a processor configured to execute program instructions that cause the processor to:
present a user interface that is configured to receive one or more search terms from a user;
forward the one or more search terms to a selected search engine;
receive search results from the selected search engine in response to the one or more search terms;
present a card for each search result, wherein each card includes a control that is selectable by the user to add the card to a collection of cards with information about a topic; and
a memory for storing collections of cards.

12. The computer system of claim 11, wherein at least one card in the collection is created from an internet search result.

13. The computer system of claim 11, wherein at least one card in the collection is derived from a collection of another user of the computer system.

14. The computer system of claim 11, where at least one card in the collection stores information received from another user about the topic.

15. The computer system of claim 11, wherein at least one card in the collection stores information from the user about the topic.

16. The computer system of claim 11, wherein the processor is configured to execute instructions that present suggestions to the user when a search term is being entered, wherein the suggestions include search terms from other collections of cards that are stored in the memory.

17. The computer system of claim 11, wherein the processor is configured to execute instructions to receive an indication of a selected search engine from a number of internal and third-party search engines and to transmit the received search terms to the selected search engine.

18. The computer system of claim 11, wherein the processor is configured to execute instructions that operate a converter that converts plain text received for a card into HTML and determines if a URL is present in the text, wherein the converter operates to include relevant site description, site title, site images and rich-media such as an embedded video player and embedded documents that are not user generated if a URL is detected.

19. The computer system of claim 11, wherein the processor is configured to execute instructions that display the collection of cards on a web page.

20. The computer system of claim 11, wherein the processor is configured to store meta-data about a card that includes search terms associated with the card.
